(19) United States
(12) Patent Application Publication
(10) Pub. No.: US 2008/0065462 A1
(43) Pub. Date: Mar. 13, 2008

(54) Determining which potential customers to solicit for new product or service

(75) Inventors: Masaru Yamamoto, Kanagawa-ken (JP); Yoshiaki Kobayashi, Tokyo (JP); Hiroyuki Miyajima, Kanagawa-ken (JP); Yoshiaki Sawano, Zama-shi (JP)

Correspondence Address: LAW OFFICES OF MICHAEL DRYJA, 1474 N COOPER RD #105-248, GILBERT, AZ, 85233, US

(73) Assignee: International Business Machines Corporation, Armonk, NY (US)

(21) Appl. No.: 11/467,535

(22) Filed: Aug. 25, 2006

(51) Int. Cl. G06F 17/30

(52) U.S. Cl. 705/10

(57) ABSTRACT

A number of potential customers for a product or service are segmented into a number of clusters organized over a number of dimensions by one or more attributes of the potential customers. Each potential customer is segmented into no more than one cluster. No data exists regarding the potential customers as to purchase of the product or service. A number of initial clusters are selected. The success factor of each of these initial clusters is determined. For the initial cluster having the highest success factor, one or more subsequent clusters are selected that are located near this initial cluster. The success factor of each of these subsequent clusters is then determined. For the subsequent cluster having the highest success factor, the potential customers segmented into this cluster are solicited as the most likely customers of the product or service in question.

### FIELD OF THE INVENTION

The present invention relates generally to determining which customers to solicit for a product or service, and more particularly to determining which potential customers to solicit for a new product or service, where no data exists regarding these customers as to the purchase of the product or service.

### BACKGROUND OF THE INVENTION

Customers are commonly solicited for products or services via direct mail, email, and phone calls from telemarketing centers. It is generally desirable to generate lists of potential customers that will purchase a given product or service with high probability. Therefore, limited resources are dedicated to those customers who are most likely to purchase a product or service.

Conventionally, methodologies such as online analytical processing and data mining have been used as a way to target customers that should be solicited. Such methodologies typically find certain principles or rules by performing statistical analysis on existing purchase data. The principles or rules can then be applied to a given customer having previous purchase data to determine whether the customer should be solicited for a product or service.

However, these existing methodologies fall short for new products or services, since there is no existing purchase data regarding these new products or services. That is, for a new product or service, no potential customer has ever purchased the product or service, and no other customers exist as to such purchase data. As a result, there is no existing such data by which conventional methodologies can be employed.

Within the prior art, therefore, what is commonly done to target potential customers for a new product or service is to either take a random approach to selecting customers, or applying an existing methodology to similar products or services for which there is existing purchase data. However, each of these approaches is disadvantageous. With respect to a random approach, a great amount of time may be required to construct sales records to a level at which statistical analysis can then be performed. With respect to applying an existing methodology to a similar product or service, there may be gaps between the estimated target customer base and the actual purchasers, such that the most likely customers for a new product or service may be overlooked.

For these and other reasons, therefore, there is a need for the present invention.

### SUMMARY OF THE INVENTION

The present invention relates to determining which potential customers should be solicited for a new product or service. A method of one embodiment of the invention segments a number of potential customers for a product or service into a number of clusters organized over a number of dimensions by one or more attributes of the potential customers. Each potential customer is segmented into no more than one cluster. No data exists regarding the potential customers as to purchase of the product or service. That is, the product or service is new, such that none of the potential customers has ever purchased the product or service, and no other customers exist that have purchased the product or service, such that there is no purchase data of the product or service.

A number of initial clusters are selected. The success factor of each of these initial clusters (i.e., at each of the points) is determined. The success factor may be a probability that the customers within a given cluster are likely to purchase the product or service, and may be determined empirically or in another manner.

For the initial cluster having the highest success factor, one or more subsequent clusters are selected that are located near this initial cluster. These subsequent clusters may be the neighboring clusters to the initial cluster having the highest success factor, for instance. The success factor of each of these subsequent clusters is then determined. For the subsequent cluster having the highest success factor, the potential customers segmented into this cluster are solicited as the most likely customers of the product or service in question.

In another embodiment of the invention, the method that has been described may be iteratively performed, such that clusters near the subsequent clusters are examined, and this process is repeated until the cluster having the highest success factor is located. In one embodiment, an article of manufacture has a tangible computer-readable medium on which a computer program is stored to perform one of the methods that has been described. The medium may be a recordable data storage medium, or another type of tangible computer-readable medium.

Embodiments of the invention provide for advantages over the prior art. In particular, the methods that have been described determine the most likely customers of a product or service, even where there is insufficient past purchase data regarding this product or service, which is the case where the product or service is brand new. Compared to the randomized approach of the prior art, the approach of the invention does not require as much time or resources to undertake, and further more quickly locates the most likely customers. Compared to the approach of the prior art in which past purchase data of similar products or services is employed, the approach of the invention is more likely to locate the better potential customers of a new product or service.

Still other advantages, aspects, and embodiments of the invention will become apparent by reading the detailed description and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of a method, according to an embodiment of the invention.

FIGS. 2A, 2B, and 2C are diagrams illustrating example performance of some parts of the method of FIG. 1, according to an embodiment of the invention.

FIG. 3 is a flowchart of a method more detailed than but consistent with the method of FIG. 1, according to an embodiment of the invention.

FIG. 4 is a diagram of a representative system, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

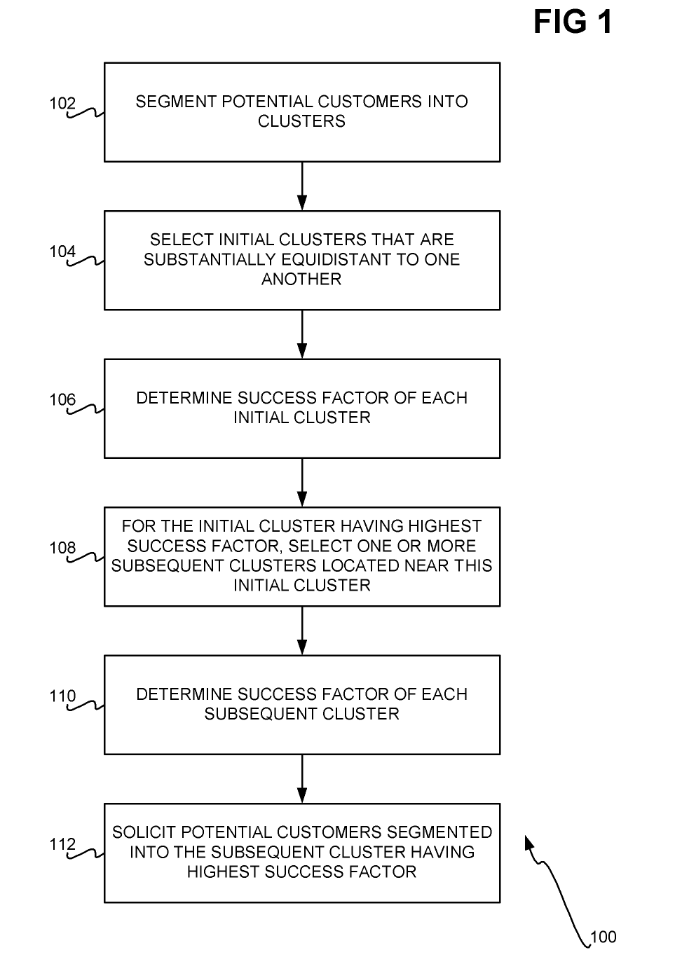

FIG. 1 shows a method 100, according to an embodiment of the invention. The method 100 is implemented in a computerized manner. As such, a computer program may be developed to perform the method 100. The computer-program may be stored on a tangible computer-readable medium, such as a recordable data storage medium.

The method 100 segments potential customers of a product or service into a number of clusters organized over a number of dimensions by one or more attributes of the potential customers (102). Thus, each potential customer has one or more attributes, such as age, gender, location, income, and so on. The product or service is new, such that no previous purchase data exists as to the product or service. That is, there is no previous history as to other customers having purchased the product or service. Importantly, then, the attributes of the potential customers do not include previous purchasing history of the product or service, or, in at least some embodiments, of other, similar products or services.

Each potential customer is segmented into just one cluster. The number of dimensions of the clusters can in one embodiment correspond to the number of attributes of the potential customers. Any predetermined clustering algorithm may be employed to cluster the potential customers in accordance with their attributes. As can be appreciated by those of ordinary skill within the art, clustering is a common technique for statistical data analysis. Clustering is the classification of similar objects (here, similar potential customers) into different groups (i.e., clusters), or more precisely, the partitioning of a data set into subsets (clusters), so that the data in each subset (ideally) share some common trait.

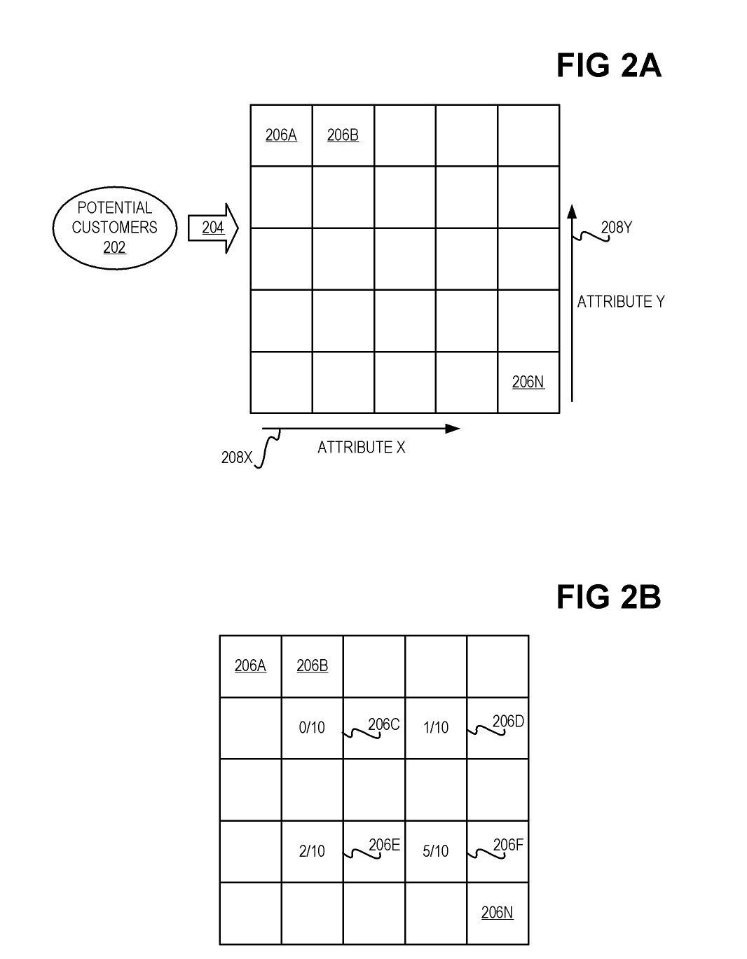

FIG. 2A shows example and representative performance of part 102 of the method 100 of FIG. 1, according to an embodiment of the invention. There are potential customers 202, each of which has at least two attributes: a first attribute denoted as the attribute X, and a second attribute denoted as the attribute Y. The potential customers 202 are clustered into a number of clusters 206A, 206B, . . . , 206N, collectively referred to as the clusters 206, as indicated by the arrow 204. The clusters 206 are organized over two dimensions: a first dimension 208X corresponding to the attribute X, and a second dimension 208Y corresponding to the attribute Y. It is noted that in general, there is no limit as to the number of dimensions over which the clusters 206 are organized, however.

Referring back to FIG. 1, a number of initial clusters are selected that are substantially equidistant to one another (104). Stated another way, a number of points are selected within the clusters, where the points are substantially equidistant to one another. Thus, the initial clusters or points are not selected randomly, but rather are selected so that they are dispersed over all the clusters. In another embodiment, the clusters may be selected in a different manner, such that they are not necessarily substantially equidistant to one another. That is, the invention itself is not limited to cluster selection where the clusters are substantially equidistant to one another.

Thereafter, what is referred to as a success factor is determined for each initial cluster (106), or for each cluster that contains or encompasses a selected point. The success factor is determined in one embodiment by particularly employing a number of approaches for centering on or reaching a given cluster, and assessing which of these approaches, as compared to the total number of approaches tried, actually center on or reach the cluster in question, as the success factor. In another embodiment, empirical analysis may be performed, so that a representative sample of a given cluster are solicited with the new product or service, and the percentage of potential customers of the sample that purchase the product or service is the success factor of the cluster.

In the embodiment where a number of approaches are employed for centering on or reaching a given cluster, where the percentage of successful approaches for the cluster is the success factor of the cluster, these approaches may be statistical analysis approaches as known within the art. The approaches are preferably different approaches, so that there is diversity within the ways in which a given cluster yields a high probability that potential customers segmented thereinto most likely to purchase the product or service, to ensure that a given confidence in the resulting success factor. Such different approaches for centering on or reaching a given cluster can include randomly selecting the clusters, for instance, as well as other types of approaches, as can be appreciated by those of ordinary skill within the art.

FIG. 2B shows example and representative performance of parts 104 and 106 of the method 100 of FIG. 1, according to an embodiment of the invention. The clusters 206 are depicted in FIG. 2B as also include the clusters 206C, 206D, 206E, and 206F. The clusters 206C, 206D, 206E, and 206F have been selected as the initial clusters in part 104, and are substantially equidistant to one another in one embodiment, but not all embodiments, of the invention. Thus, the clusters 206C, 206D, 206E, and 206F are not randomly selected in at least some embodiments, but rather are selected in one embodiment of the invention so that they are at least substantially equidistant to one another, as is the case in FIG. 2B, where each of these clusters is located two clusters apart from the other of the clusters.

The success factors of the clusters 206C, 206D, 206E, and 206F are denoted in FIG. 2B as 0/10, 1/10, 2/10, and 5/10, respectively. These success factors are representative of the embodiment of the invention where a number of approaches are utilized to determine whether a given approach ultimately centers on a given cluster. For all the approaches tried for a given cluster, the success factor is a fraction indicating the number of these approaches that successfully centered on the cluster in question.

Thus, for the initial cluster 206C, zero out of ten approaches tried successfully centered on the cluster 206C. For the initial cluster 206D, one out of ten approaches tried successfully centered on the cluster 206D. For the initial cluster 206E, two out of ten approaches tried successfully centered on the cluster 206E. For the initial cluster 206F, five out of ten approaches tried successfully centered on the cluster 206F.

Referring back to the method 100 of FIG. 1, for the initial cluster having the highest success factor, what are referred to as one or more subsequent clusters are selected (108). These subsequent clusters are located near this initial cluster. For instance, the neighboring clusters to the initial cluster having the highest success factor may be selected as the subsequent clusters. Thereafter, the success factor of each subsequent cluster is determined (110), in the same way as has been described in relation to the initial clusters in part 106 of the method 100.

Therefore, the insight followed by at least some embodiments of the invention is that the success factors of clusters are themselves grouped or clustered together. As such, it is presumed that the cluster having the highest success factor will be located near the initial cluster that has the highest success factor among the initial clusters. Rather than determining the success factors of all the clusters, then, embodiments of the invention selectively locate which clusters are likely to have the highest success factors, and only actually determine the success factors for these clusters.

FIG. 2C shows example and representative performance of parts 108 and 110 of the method 100 of FIG. 1, according to an embodiment of the invention. The clusters 206 are depicted in FIG. 2B as also including the clusters 206G and 206H. The cluster 206F is the initial cluster having the highest success factor as has been described in relation to FIG. 2B. The clusters 206G, 206H, and 206N are selected as the subsequent clusters to this initial cluster.

In particular, the clusters to the right, to the bottom, and to the bottom right diagonally of the initial cluster 206F are selected as the subsequent clusters in the example of FIG. 2C. All the subsequent clusters 206G, 206H, and 206N are direct neighbors to the initial cluster 206F. The other direct neighbors to the initial cluster 206F are not selected as subsequent clusters in the example of FIG. 2C. The reason why is these other five neighbor clusters to the initial cluster 206F are located relatively close to the other initial clusters 206C, 206D, and 206E.

Therefore, because it is presumed that the success factors of the clusters 206 are themselves clustered or grouped together, these other neighbor clusters to the initial cluster 206F are presumed to have lower success factors than the success factor of the cluster 206F. That is, since these other neighbor clusters to the initial cluster 206F are located relatively close to the other initial clusters 206C, 206D, and 206E, then they are presumed to have success factors between the success factor of the initial cluster 206F and the success factors of the clusters 206C, 206D, and 206E. As such, they are presumed to not have higher success factors than the cluster 206F in the particular example of FIG. 2C.

The success factors of the selected subsequent clusters 206G, 206H, and 206N are denoted in FIG. 2C as 7/10, 4/10, and 6/10, respectively. As in FIG. 2B, these success factors are representative of the embodiment of the invention where a number of approaches are utilized to determine whether a given approach ultimately centers on a given cluster. For all the approaches tried for a given cluster, the success factor is a fraction indicating the number of these approaches that successfully centered on the cluster in question. Therefore, in the example of FIG. 2C, the cluster 206G has the highest success factor of any of the subsequent clusters 206G, 206H, and 206N, and indeed has a higher success factor than the initial cluster 206F.

Referring back to the method 100 of FIG. 1, the method 100 desirably concludes by soliciting the potential customers segmented into the (subsequent) cluster having the highest success factor (112). That is, this cluster is denoted by the method 100 as that which contains the potential customers who are most likely to purchase the new product or service, with a high degree of certainty, even though actual purchase data of the product or service does not yet exist, as has been described. For instance, in the examples of FIGS. 2A, 2B, and 2C, the potential customers segmented into the cluster 206G are solicited in part 112 of the method 100 as the most likely purchasers of any of the potential customers of the product or service in question.

It is noted that if none of the subsequent clusters has a higher success factor of the initial cluster having the highest success factor, then the potential customers segmented into this initial cluster are solicited in part 112. In this case, this initial cluster is referred to herein as a subsequent cluster, insofar as it is ultimately the cluster having the highest success factor of any cluster for which success factors have been determined. Thus, ultimately the potential customers segmented into the cluster having the highest success factor of any cluster for which success factors have been determined are those that are solicited for the new product or service.

It is also noted that the method 100 as has been described in the embodiment of FIG. 1 is a two-stage process. In a first stage, initial clusters are selected and the success factors of these initial clusters are determined, in parts 104 and 106. In a second stage, subsequent clusters are selected as located near the initial cluster having the highest success factor, and the success factors of these subsequent clusters are determined, in parts 108 and 110.

However, in another embodiment, the method 100 may be performed even more iteratively. Thus, if a subsequent cluster has a higher success factor than the initial cluster, then this subsequent cluster is selected as the new initial cluster, and the method 100 is repeated by selecting new subsequent clusters to the new initial cluster, and so on. Ultimately, at some point, no subsequent cluster will be located that has a higher success factor than the current initial cluster, in which case the method 100 ends by soliciting the potential customers segmented into this current initial cluster.

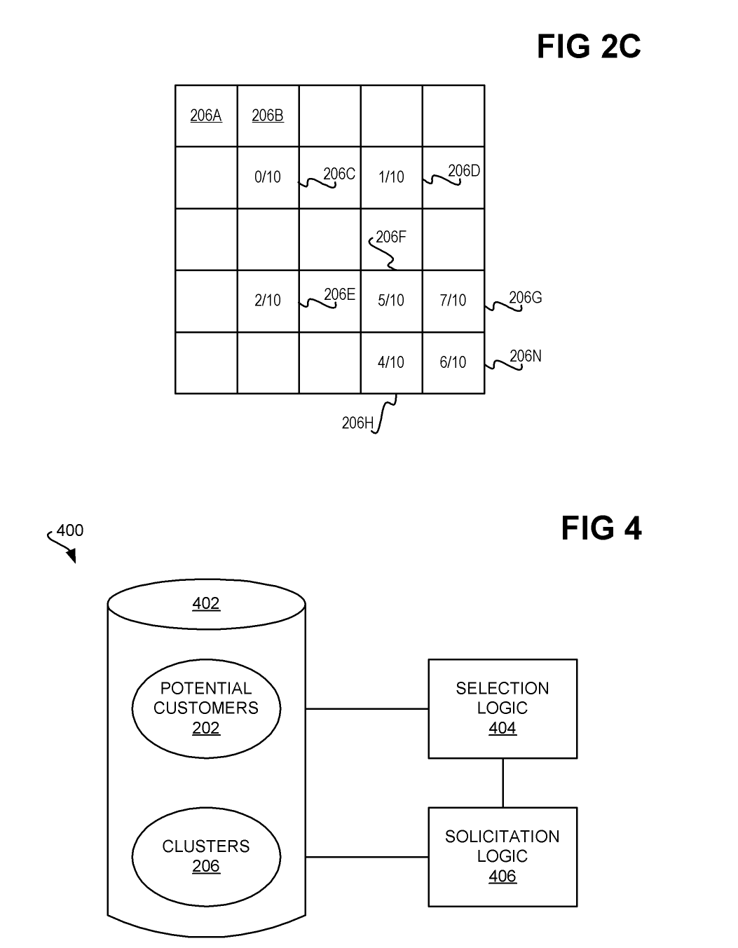

Therefore, FIG. 3 shows the method 100 having such an iterative approach, according to an embodiment of the invention. The method 100 of the embodiment of FIG. 3 is consistent with but more detailed than the method 100 of the embodiment of FIG. 1. Similarly performed or like-performed parts of the method 100 between FIGS. 1 and 3 are denoted with the same reference numbers in the figures.

As before, the potential customers are segmented into a number of clusters (102). In one embodiment, but not all embodiments, of the invention, initial clusters are then selected that are substantially equidistant to one another (104). The success factor of each initial cluster is determined (106), and the initial cluster with the highest success factor is selected or denoted as what is referred to as the standard cluster (302).

Thereafter, what are referred to as candidate clusters, comparable to the subsequent clusters described before, are selected (108), as located near the standard cluster. The candidate clusters may be one or more neighboring clusters to the standard cluster, for instance. The success factor of each such candidate cluster is determined (110), as has been described in relation to the subsequent clusters and the initial cluster in the method 100 of FIG. 1.

If the success factor of a candidate cluster is greater than the success factor of the standard cluster (304), then this candidate cluster is selected as the new standard cluster (306), and the method 100 of FIG. 3 repeats at part 108 in relation to this new standard cluster. Thus, the method 100 of FIG. 3 is iteratively performed where a candidate cluster is located that is better than the standard cluster. At some point, the success factors of none of the candidate clusters are greater than the success factor of the standard cluster (304). In this case, it can be concluded with sufficiently high probability that the standard cluster is the best cluster, such that the potential customers segmented into the standard cluster are solicited (112), as before.

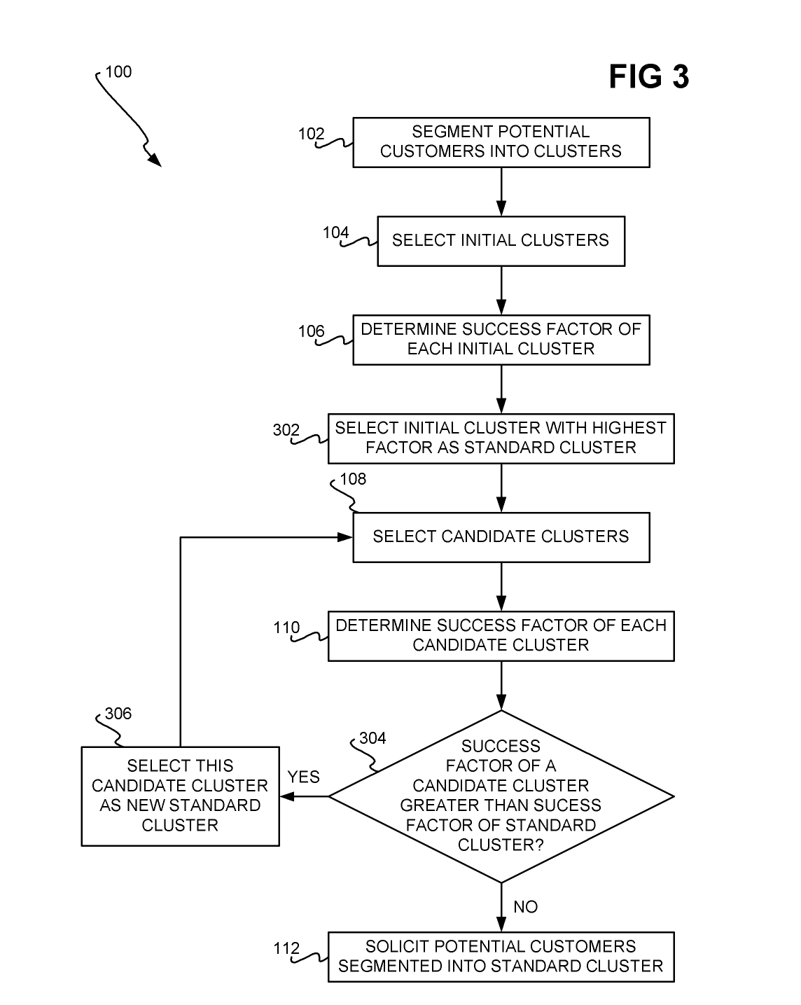

FIG. 4 shows a computerized system 400, according to an embodiment of the invention. The system 400 is depicted in FIG. 4 as including a computer-readable medium 402, selection logic 404, and solicitation logic 406. As can be appreciated by those of ordinary skill within the art, the system 400 may include other components, in addition to and/or in lieu of those depicted in FIG. 4. The logic 404 and the logic 406 can be implemented in software, hardware, or a combination of software and hardware.

The computer-readable medium 402 is a tangible computer-readable medium, such as a recordable data storage medium, and stores the potential customers 202 and the clusters 206 that have been described. The selection logic 404 performs nearly all of the parts of the method 100 of FIG. 1 and/or FIG. 3 that has been described. That is, the logic 404 segments the customers 202 into the clusters 206, and selects the cluster having the potential customers most likely to purchase a given product or service. Thereafter, the solicitation logic 406 performs part 112 of the method 100. That is, the logic 406 solicits or assists solicitation of the potential customers segmented into the cluster selected by the logic 404, by email, telephone call, regular mail, and so on.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A method comprising:
segmenting a plurality of potential customers of a product or service into a plurality of clusters organized over a plurality of dimensions by one or more attributes of the potential customers where no data exists regarding the potential customers as to purchase of the product or service, each potential customer segmented into no more than one cluster;
selecting a plurality of initial clusters among the plurality of clusters organized over the plurality of dimensions;
determining a success factor of each initial cluster;
for the initial cluster having a highest success factor, selecting one or more subsequent clusters among the plurality of clusters located near the initial cluster having the highest success factor;
determining a success factor of each subsequent cluster; and,
for the subsequent cluster having a highest success factor, soliciting the potential customers segmented into the subsequent cluster having the highest success factor as most likely customers of the product or service.

2. The method of claim 1, further comprising, after determining the success factor of each subsequent cluster:
a) for the subsequent cluster having the highest success factor, selecting one or more new subsequent clusters among the plurality of clusters located near the subsequent cluster having the highest success factor;
b) determining a success factor of each new subsequent cluster;
c) where the success factor of a new subsequent cluster is greater than the success factor of the subsequent cluster, repeating at a) with respect to the new subsequent cluster; and,
d) otherwise, selecting the subsequent cluster having the highest success factor as to which the potential customers segmented thereinto are solicited as most likely customers of the product or service.

3. The method of claim 1, wherein the potential customers of the product or service are potential in that the product or service is new, such that none of the potential customers has ever purchased the product or service, and no other customers exist as to purchase data of the product or service.

4. The method of claim 1, wherein segmenting the plurality of potential customers into the plurality of clusters comprises employing a predetermined clustering algorithm.

5. The method of claim 1, wherein the plurality of dimensions is equal to two.

6. The method of claim 1, wherein selecting the plurality of initial clusters comprises selecting a plurality of points within the plurality of clusters that are substantially equidistant to one another.

7. The method of claim 6, wherein determining the success factor of each initial cluster comprises determining the success factor of a cluster containing a point.

8. The method of claim 1, wherein determining the success factor of each initial cluster comprises employing one or more approaches that center on the initial cluster.

9. The method of claim 1, wherein selecting the subsequent clusters located near the initial cluster having the highest success factor comprises selecting the subsequent clusters as neighboring clusters to the initial cluster having the highest success factor.

10. The method of claim 1, wherein determining the success factor of each subsequent cluster comprises employing one or more approaches that center on the subsequent cluster.

11. A method comprising:
a) segmenting a plurality of potential customers of a product or service into a plurality of clusters organized over a plurality of dimensions by one or more attributes of the potential customers where no data exists regarding the potential customers as to purchase of the product or service, each potential customer segmented into no more than one cluster;
b) selecting a plurality of initial clusters among the plurality of clusters organized over the plurality of dimensions;
c) determining a success factor of each initial cluster, the initial cluster having a highest success factor referred to as a standard cluster;
d) selecting one or more candidate clusters among the plurality of clusters located near the standard cluster;
e) determining a success factor of each candidate cluster;
f) where the success factor of a candidate cluster is higher than the success factor of the standard cluster,
selecting the candidate cluster having the success factor higher than the success factor of the standard cluster as a new standard cluster;
repeating at d) with respect to the new standard cluster;
g) otherwise, soliciting the potential customers segmented into the standard cluster as most likely customers of the product or service.

12. The method of claim 11, wherein the potential customers of the product or service are potential in that the product or service is new, such that none of the potential customers has ever purchased the product or service, and no other customers exist as to purchase data of the product or service.

13. The method of claim 11, wherein selecting the plurality of initial clusters comprises selecting a plurality of points within the plurality of initial clusters that are substantially equidistant to one another.

14. The method of claim 11, wherein determining the success factor of each initial cluster comprises employing one or more approaches that center on the initial cluster.

15. The method of claim 11, wherein selecting the candidate clusters located near the standard cluster comprises selecting the subsequent clusters as neighboring clusters to the standard cluster.

16. An article of manufacture having a tangible computer-readable medium on which a computer program is stored to perform a method comprising:
segmenting a plurality of potential customers of a product or service into a plurality of clusters organized over a plurality of dimensions by one or more attributes of the potential customers where no data exists regarding the potential customers as to purchase of the product or service, each potential customer segmented into no more than one cluster;
selecting a plurality of initial clusters among the plurality of clusters organized over the plurality of dimensions;
determining a success factor of each initial cluster;
for the initial cluster having a highest success factor, selecting one or more subsequent clusters among the plurality of clusters located near the initial cluster having the highest success factor;
determining a success factor of each subsequent cluster,
wherein, for the subsequent cluster having a highest success factor, the potential customers segmented into the subsequent cluster having the highest success factor are solicited as most likely customers of the product or service.

17. The article of manufacture of claim 16, wherein the potential customers of the product or service are potential in that the product or service is new, such that none of the potential customers has ever purchased the product or service, and no other customers exist as to purchase data of the product or service.

18. The article of manufacture of claim 16, wherein selecting the plurality of initial clusters comprises selecting a plurality of points within the plurality of initial clusters that are substantially equidistant to one another.

19. The article of manufacture of claim 16, wherein determining the success factor of each initial cluster comprises employing one or more approaches that center on the initial cluster.

20. The article of manufacture of claim 16, wherein selecting the subsequent clusters located near the initial cluster having the highest success factor comprises selecting the subsequent clusters as neighboring clusters to the initial cluster having the highest success factor.
